(19) United States
(12) Patent Application Publication
(10) Pub. No.: US 2017/0361341 A1
(43) Pub. Date: Dec. 21, 2017

(54) ROTOR NOZZLE FOR A HIGH-PRESSURE CLEANING APPARATUS

(71) Applicant: Alfred Kärcher GmbH & Co. KG, Winnenden (DE)

(72) Inventors: Sven Dirnberger, Steinheim (DE); Bjoern Schwarz, Backnang (DE); Stefan Werner, Stuttgart (DE); Johann Georg Wesch, Urbach (DE)

(21) Appl. No.: 15/691,352

(22) Filed: Aug. 30, 2017

Related U.S. Application Data
(63) Continuation of application No. PCT/EP2015/054310, filed on Mar. 2, 2015.

(51) Int. Cl. B05B 3/04; B05B 1/02

(52) U.S. Cl. CPC B05B 3/0463; B05B 1/02

(57) ABSTRACT

A rotor nozzle for a high-pressure cleaning apparatus is provided, with a housing having an inlet opening tangentially into the housing and an outlet arranged on an end wall and on which is arranged a pan-shaped, centrally broken recess. A nozzle body arranged in the housing, having a through channel, and supported with a spherical end in the pan-shaped recess has a longitudinal axis tilted toward the longitudinal axis of the housing. The nozzle body is brought into a revolving movement by liquid flowing through the housing and supported on a support surface, of which flow resistance elements, each having one baffle surface, are arranged downstream of on the wall of the housing. A guiding surface is arranged upstream of each baffle surface and is continuously adjoined by the baffle surface, wherein the guiding surface is aligned obliquely to a radial plane of the housing.

### CROSS-REFERENCE TO RELATED APPLICATIONS

This application is a continuation of international application number PCT/EP2015/054310 filed on Mar. 2, 2015, which is incorporated herein by reference in its entirety and for all purposes.

### BACKGROUND OF THE INVENTION

The invention relates to a rotor nozzle for a high-pressure cleaning apparatus with a housing having at least one inlet opening tangentially into the housing and an outlet which is arranged on an end wall of the housing and on which is arranged a bearing with a pan-shaped, centrally broken recess, and with a nozzle body which is arranged in the housing, has a through channel, and is supported with a spherical end in the pan-shaped recess, the longitudinal axis of which nozzle body is tilted toward the longitudinal axis of the housing and which nozzle body is brought into a revolving movement by the liquid flowing through the housing, in which revolving movement the longitudinal axis of the nozzle body revolves on a conical shell and the nozzle body is supported with a contact surface on its circumference on a support surface, wherein several flow resistance elements are arranged downstream of the support surface on the wall of the housing in the circumferential direction at a distance to one another, which flow resistance elements respectively have one baffle surface protruding into the internal space for impinging liquid.

By means of such a rotor nozzle, a compact liquid jet revolving on a conical shell can be produced, which liquid jet can, for example, be directed at a surface for cleaning purposes. Pressurized liquid from a high-pressure cleaning apparatus can be supplied to the inlet of the housing. In the housing is located a nozzle body which is mounted on the pan-shaped recess on only one side and which can otherwise move in the housing about the longitudinal axis of the housing. The nozzle body has a through channel, through which the liquid can pass through the broken recess of the housing. The longitudinal axis of the nozzle body is tilted with respect to the longitudinal axis of the housing. The nozzle body is pressed into the pan-shaped recess by the liquid tangentially entering the housing, which recess forms a bearing for the nozzle body, and at the same time, the nozzle body is brought into rotation about the housing longitudinal axis. This has the consequence that the exiting liquid jet also describes the desired circular movement so that the liquid can be applied to a relatively large area with a pressure comparable to spot jet nozzles.

Supplying the pressurized liquid via the inlet tangentially opening into the housing ensures that liquid located in the housing is brought into rotation about the longitudinal axis of the housing and that the nozzle body thereby also rotates about the housing longitudinal axis as a rotating liquid column forms inside the housing.

If the nozzle body has a very high rotational speed about the longitudinal axis of the housing, the consequence can be that the liquid jet exiting the outlet is fanned out and that the cleaning effect of the liquid jet impinging on an area is reduced thereby. DE 44 19 404 A1 therefore suggests to arrange several flow resistance elements disposed over the circumference on the inside wall of the housing, which flow resistance elements decelerate the flow of the liquid and thereby also reduce the rotational speed of the nozzle body. The flow resistance elements are formed by lamellas which are arranged on the upstream end of an insert that can be inserted into the housing. The insert can be moved in the longitudinal direction of the housing and has at its upstream end a plurality of slot-shaped recesses which form the lamellas between them. The lamellas respectively form a baffle surface for the flowing liquid, wherein the baffle surface opposes the liquid.

The rotational speed that the nozzle body has in its rotation about the housing longitudinal axis is indirectly reduced by the flow resistance elements arranged on the inside of the housing as the flow resistance elements act on the revolving liquid in a decelerating manner. It is desirable to limit the rotational speed of the nozzle body in its rotational movement about the housing longitudinal axis as effectively as possible. However, it must also be ensured that the so-called “start-up behavior” of the nozzle body is not impaired. The term “start-up behavior” refers to the starting of the rotation of the nozzle body about the housing longitudinal axis. Before pressurized liquid is supplied to the housing, the nozzle body is at rest relative to the housing, i.e., it does not yet carry out a revolving movement about the housing longitudinal axis. If pressurized liquid is now supplied via the at least one tangential inlet, the nozzle body must be brought into rotation reliably. If the nozzle body then carries out the rotational movement, the rotational speed of the nozzle body should not exceed a maximum rotational speed in order to avoid a fanning out of the liquid jet exiting the outlet.

The object of the present invention is therefore to further develop a rotor nozzle of the aforementioned type such that the rotational speed that the nozzle body has in its rotational movement about the housing longitudinal axis can be effectively limited without the start-up behavior of the nozzle body being noticeably impaired.

### SUMMARY OF THE INVENTION

This object is accomplished according to the invention in a rotor nozzle of the generic type by a guiding surface being arranged directly upstream of each baffle surface with respect to the flow direction of the liquid, which guiding surface is continuously adjoined by the baffle surface, wherein the guiding surface is aligned obliquely to a radial plane with respect to the longitudinal axis of the housing.

In the rotor nozzle according to the invention, a guiding surface is arranged upstream of each baffle surface, which guiding surface is continuously adjoined by the respective baffle surface in the flow direction of the liquid. The guiding surfaces are aligned obliquely to a radial plane with respect to the longitudinal axis of the housing. The oblique alignment of the guiding surfaces has the consequence that revolving liquid is supplied along the guiding surfaces to the baffle surfaces, which oppose the revolving movement of the liquid. A significant deceleration of the liquid flow can thereby be achieved and this, in turn, has the consequence that the rotational speed that the nozzle body has in its rotational movement about the housing longitudinal axis can be limited effectively.

The flow resistance elements are arranged downstream of the support surface, on which the nozzle body is supported on the inside wall of the housing. In the region between the at least one inlet of the housing and the support surface, no flow resistance elements are arranged, which could impair the movement of the liquid. This ensures that the start-up behavior of the nozzle body is not noticeably impaired despite the use of the baffle surfaces and guiding surfaces.

It has been shown that the use of baffle surfaces and guiding surfaces cannot only limit the rotational speed that the nozzle body has in its revolving movement about the housing longitudinal axis but can also keep low the self-rotation of the nozzle body, i.e., the rotation that the nozzle body exhibits about its own longitudinal axis. Because the liquid rotating in the housing does not only have the consequence that the nozzle body rotates about the housing longitudinal axis according to the liquid. Rather, the nozzle body, in particular in its front region directly adjacent to the pan-shaped recess, is driven by the revolving liquid to a rotation about the longitudinal axis of the nozzle body. The self-rotation about the longitudinal axis of the nozzle body superposes the revolving movement of the nozzle body on the conical shell of the housing. The self-rotation has the consequence that the liquid jet flowing out of the nozzle body is also brought into rotation about its longitudinal axis. This results in an additional fanning out of the liquid jet, which fanning out impairs the cleaning effect of the liquid jet. The positioning of the baffle surfaces and guiding surfaces downstream of the support surface, on which the nozzle body is supported on the wall of the housing, results precisely in the region of the nozzle body in a deceleration of the revolving movement of the liquid jet, as a self-rotation of the nozzle body is induced by the liquid jet. The use of the baffle surfaces and guiding surfaces thus cannot only limit the rotational speed that the nozzle body has in its revolving movement about the housing longitudinal axis but can also limit the rotational speed of the self-rotation of the nozzle body.

As already mentioned, the baffle surfaces oppose the revolving movement of the liquid. The baffle surfaces are preferably at least in sections arranged in a radial plane with respect to the longitudinal axis of the housing. The liquid revolving about the housing longitudinal axis can thereby impinge orthogonally on the baffle surface at least in a region of the baffle surface and can thereby experience a particularly strong deceleration.

It is particularly advantageous if the guiding surfaces are curved in the shape of an arc at least in sections. For example, it can be provided that the guiding surfaces are curved outward convexly, i.e., in the direction facing away from the longitudinal axis of the housing, at least in sections. The arc-shaped curve results in a particularly effective change of the flow of the liquid in the direction toward the baffle surface directly following the respective guiding surface.

In combination with the baffle surface adjoining the guiding surface, each guiding surface advantageously forms a channel-shaped expansion of the internal space of the housing. The channel-shaped expansion extends in the direction toward the outlet of the housing. The channel-shaped expansion is preferably aligned obliquely to the longitudinal axis of the housing, in particularly parallelly to the longitudinal axis of the nozzle body.

It is particularly advantageous if a plurality of baffle surfaces and guiding surfaces are arranged alternatingly one behind the other with respect to the flow direction of the liquid. In the circumferential direction of the housing, the baffle surfaces and the guiding surfaces thus adjoin one another, wherein each guiding surface is followed by a baffle surface which is, in turn, adjoined by a guiding surface.

In an advantageous embodiment of the invention, each guiding surface forms, in combination with the baffle surface adjoining the guiding surface, an S-shaped or sawtooth-shaped contour in a plane aligned orthogonally to the longitudinal axis of the housing. It has been shown that a particularly effective deceleration of the liquid flow in a region between the support surface on which the nozzle body is supported and the outlet of the housing can be achieved thereby.

The guiding surface advantageously extends in the circumferential direction of the housing across a larger region than the baffle surface adjoining it. It is particularly advantageous if the guiding surface extends in the circumferential direction across a region that is at least twice as large as the baffle surface following the guiding surface. The liquid is thereby respectively supplied over a relatively large circumferential region to a baffle surface and then effectively decelerated on it.

It can be provided that the flow resistance elements are formed in a wall of the housing. In such an embodiment, the flow resistance elements form, together with the housing, a one-piece component. For example, it can be provided that the flow resistance elements in combination with the housing form a one-piece injection-molded part, which is preferably produced from a plastic material.

It can alternatively be provided that the flow resistance elements are formed by an insert that can be inserted into the housing. Such an embodiment has the advantage that the housing can be designed to be relatively thin-walled, wherein it can have on its inside a relatively smooth surface without any profile. The risk of cracks forming in the housing when highly pressurized liquid is applied to the housing can thereby be kept particularly low. The insert can form a pre-assembled component, which can be inserted into the housing. The insert thus forms an additional component that provides the flow resistance elements, without the mechanical resilience of the housing being impaired thereby.

It is particularly advantageous if the insert has a constant wall thickness along its circumference. This facilitates the shaping of the insert in an injection molding process. In such an embodiment, the insert has on its outside a contour that corresponds to the inside contour of the insert.

In an advantageous embodiment, the insert can be connected to the housing in a rotationally fixed and axially unmovable manner. Despite the deceleration effect it exerts on the revolving liquid, the insert does not carry out a rotational movement or an axial movement relative to the housing in such an embodiment. Such relative movements could result in damage to the insert and/or to the housing. The provision of a rotationally fixed and axially unmovable connection between the insert and the housing therefore allows for a longer service life of the rotor nozzle.

The insert can preferably be screwed to the housing and has a stop surface, which rests against an inner shoulder of the housing in the final position of the insert. The insert can in such an embodiment of the invention be screwed into the housing until it rests with its stop surface against an inner shoulder of the housing. An additional rotational movement or axial movement of the insert relative to the housing is then no longer possible.

Advantageously, the insert comprises an external thread, which interacts with a first internal thread of the housing.

The external thread of the insert is advantageously arranged downstream of the flow resistance elements. For this purpose, the housing has, upstream of the pan-shaped recess, an internal thread designed to be complementary to the external thread of the insert.

Advantageously the screw-in direction of the insert is identical to the revolving movement of the liquid inside the housing. The liquid revolving in the housing thus presses the insert into the final position, in which the insert rests with its stop surface against the inner shoulder of the housing. The revolving liquid thus ensures that the screw connection between the insert and the housing cannot be loosened unintentionally.

The internal thread of the housing is preferably designed as a multi-start thread. This has the advantage that the insert only has to be turned very little relative to the multi-start thread in order to produce a stable screw connection. For example, it can be provided that the insert must be turned relative to the housing by less than 360° in order to reach its final position.

As already mentioned, pressurized liquid is supplied to the inlet of the housing during the use of the rotor nozzle. The rotor nozzle can for this purpose have a connecting part that can be connected to the housing to connect to a liquid supply line.

The connecting part can preferably be connected to the housing in a rotationally fixed manner.

The connecting part advantageously has an external thread which can be screwed into a second internal thread of the housing.

In an advantageous embodiment, the direction of rotation of the second internal thread corresponds to the direction of rotation of the first internal thread. A corresponding direction of rotation of the two internal threads makes the shaping of the housing easier and allows for a particularly cost-effective production.

It can, however, also be provided that the direction of rotation of the second internal thread is opposed to the direction of rotation of the first internal thread. As mentioned, it is advantageous if the screw-in direction of the insert corresponds to the revolving movement of the liquid inside the housing. The insert is thereby pressed into its final position by the liquid. So that the reaction force of the housing does not result in a loosening of the screw connection between the housing and the connecting part, the direction of rotation of the second internal thread is advantageously opposite the direction of rotation of the first internal thread.

The following description of two advantageous embodiments of the invention serves the more detailed explanation in connection with the drawing. Shown are:

### BRIEF DESCRIPTION OF THE DRAWINGS

FIG. 1 a longitudinal sectional view of a first advantageous embodiment of a rotor nozzle according to the invention with a housing, in which an insert and a nozzle body are arranged;

FIG. 2 a longitudinal sectional view of a housing lid of the rotor nozzle of FIG. 1;

FIG. 3 a lateral view of the insert of the rotor nozzle of FIG. 1;

FIG. 4 a sectional view of the insert along the line 4-4 in FIG. 3;

FIG. 5 a sectional view of a housing lid of a second advantageous embodiment of a rotor nozzle according to the invention, and

FIG. 6 a sectional view of the housing lid along the line 6-6 in FIG. 5.

### DETAILED DESCRIPTION OF THE INVENTION

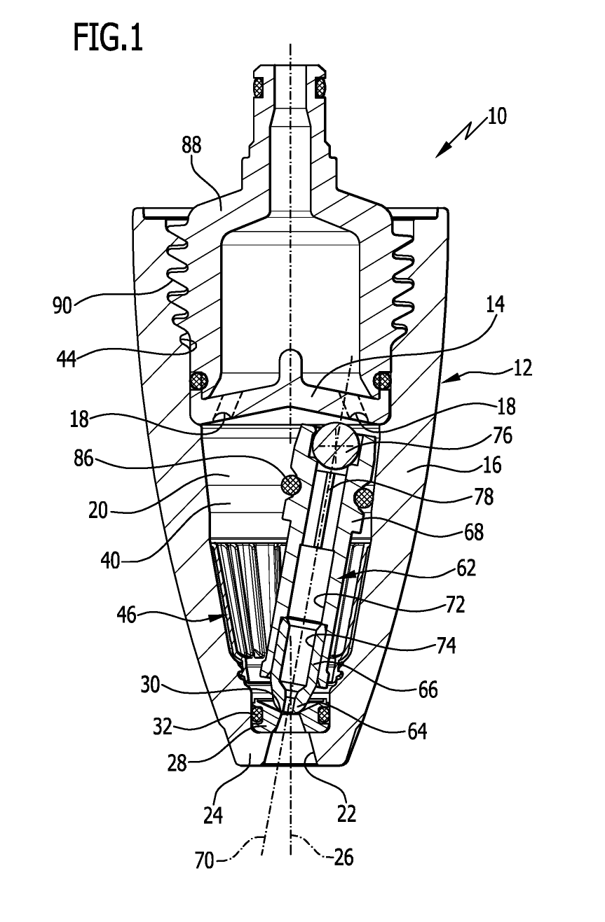

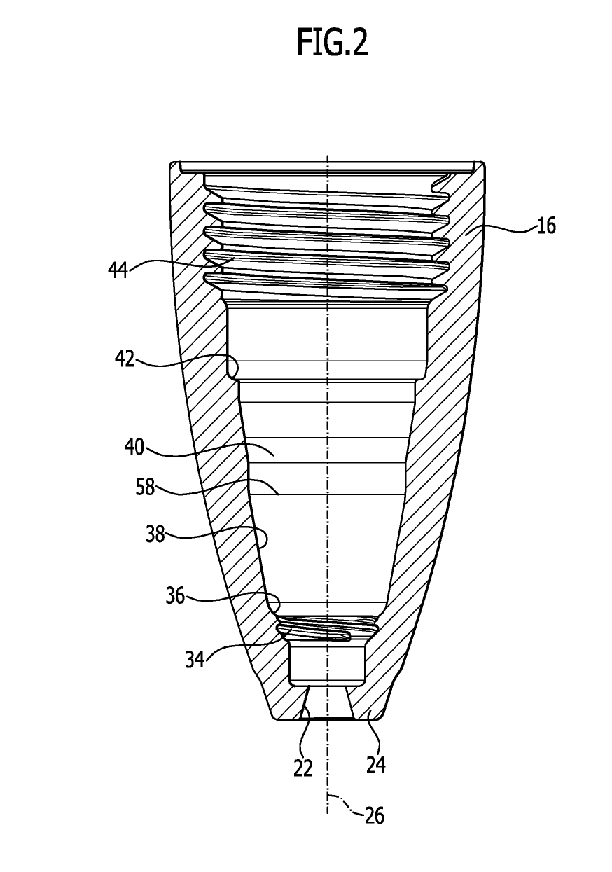

FIGS. 1 to 4 schematically show a first advantageous embodiment of a rotor nozzle according to the invention, which rotor nozzle is overall denoted by the reference symbol 10. The rotor nozzle 10 has a housing 12 with a housing bottom 14 and a housing lid 16. The housing bottom 14 is designed to be disk-shaped and has several tangential inlets 18, which open into an internal space 20 of the housing 12. The internal space 20 is surrounded by the housing lid 16 and tapers starting from the tangential inlets 18 toward an outlet 22, which is arranged on an end wall 24 of the housing lid 16.

Via the tangential inlets 18, pressurized liquid can be supplied to the internal space 20, which liquid rotates about a housing longitudinal axis 26 in the internal space 20 and can exit the housing 12 via the outlet 22.

Directly upstream of the outlet 22, a bearing in the form of a bearing ring 28 is arranged in the internal space 20, which bearing ring forms a pan-shaped recess 30. On its outside, the bearing ring 28 carries a sealing ring 32 and is thereby sealed with respect to the housing lid 16.

Upstream of the bearing ring 28, the housing lid 16 has a first internal thread 34, which is designed as a multi-start thread. In the exemplary embodiment shown, the first internal thread 34 is designed to be double-threaded. Upstream of the first internal thread 34, the housing lid 16 forms an inner shoulder 36 and, upstream of the inner shoulder 36, the housing lid 16 is designed in the shape of a conical contact region 38. Upstream of the conical contact region 38, the housing lid 16 forms a smooth support surface 40 without any profile, which support surface is designed to be conical in the exemplary embodiment shown. On the side facing away from the outlet 22, the housing lid 16 has a second inner shoulder 42 at a distance to the support surface 40, against which second inner shoulder the housing bottom 14 rests.

On the side facing away from the outlet 22, the housing lid 16 forms a second internal thread 44 at a distance to the second inner shoulder 42, the direction of rotation of which second internal thread corresponds to the first internal thread 34 in the exemplary embodiment shown. Alternatively, the direction of rotation of the second internal thread 44 can be opposed to the direction of rotation of the first internal thread 34.

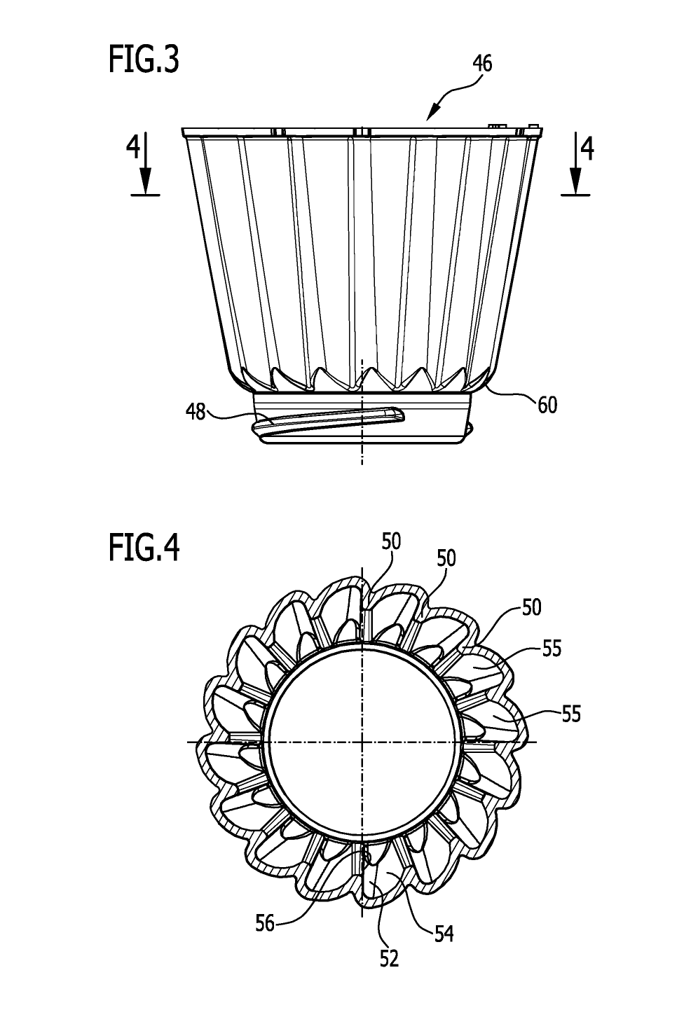

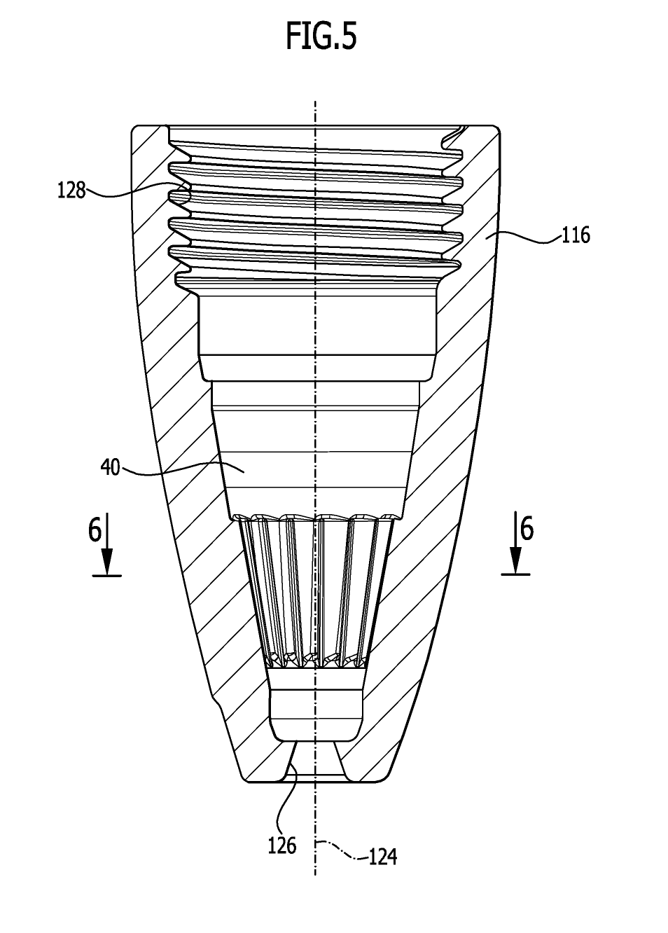

An insert 46 shown schematically in FIGS. 3 and 4 is screwed into the housing lid 16. The insert 46 has an external thread 48, which can be screwed to the first internal thread 34 of the housing lid 16. Upstream of the external thread 48, the insert 46 forms a plurality of flow resistance elements 50, which are disposed evenly in the circumferential direction and which respectively have one baffle surface 52. A guiding surface 54 is arranged upstream of each baffle surface 52 with respect to the flow direction of the liquid. The baffle surfaces and guiding surfaces 52, 54 are arranged alternatingly with each other in the circumferential direction of the insert 46 and transition into each other continuously. In a plane aligned orthogonally to the housing longitudinal axis 26, the baffle surfaces and guiding surfaces form an S-shaped contour in the exemplary embodiment shown as both the baffle surfaces 52 and the guiding surfaces 54 are curved in an arc shape. The baffle surfaces 52 have an end portion 56 aligned in a radial plane with respect to the housing longitudinal axis 26. This can be clearly seen in FIG. 4. Each guiding surface 54 forms, in combination with the adjoining baffle surface 52, a channel-shaped expansion 55, which is aligned obliquely to the longitudinal axis 26 of the housing 12.

In the circumferential direction, the insert 46 has in the region of the baffle surfaces and guiding surfaces 52, 54, a constant material thickness. This facilitates the production of the insert 46 in an injection molding process.

The insert 46 extends from the first internal thread 34 of the housing lid 16 to an upstream edge 58 of the conical contact region 38 so that the support surface 40 is not impaired by the insert 46.

In the transition region between the external thread 48 and the flow resistance elements 50, the insert 46 forms on its outside a stop surface 60 and the insert 46 can be screwed with its external thread 48 into the first internal thread 34 until the stop surface 60 rests against the first inner shoulder 36 of the housing lid 16.

After screwing the insert 46 into the housing lid 16, a nozzle body 62 can be inserted into the internal space 20, which nozzle body is supported with a spherical end 64 in the pan-shaped recess 30 of the bearing ring 28. The nozzle body 62 has a nozzle 66, which forms the spherical end 64, and a nozzle carrier 68, which has a through channel 72 extending in the axial direction along a longitudinal axis 70 of the nozzle body 62. The nozzle 66 is pressed into the through channel 72. The nozzle 66 has a nozzle channel 74 with is aligned to be flush with the through channel 72. In its end region facing away from the nozzle 66, the through channel 72 expands in a stepped manner. In the region of the expansion, a solid body, in the form of a steel ball 76, amplifying the centrifugal force, is held. Adjoining the steel ball 76 in the through channel 72 in the direction of the nozzle 66 is a rectifier 78, which has two walls standing orthogonally one above the other, extending parallelly to the longitudinal axis 70 of the nozzle body 62, and penetrating the through channel 72 diametrically.

Liquid can flow around the steel ball 76 in the through channel 72 so that the liquid, after passing the rectifier 78 and the nozzle 66, can flow through the bearing ring 28 and the outlet 22 and exit the rotor nozzle 10.

At the height of the rectifier 78, the nozzle carrier 68 has an annular groove extending in the circumferential direction, in which annular groove an O-ring 86 is held in a rotationally fixed manner. With respect to the longitudinal axis 70 of the nozzle body 62, the O-ring 86 protrudes in the radial direction beyond the nozzle carrier 68. Said O-ring forms a contact surface, with which the nozzle body 62 can rest against the support surface 40 of the housing lid 16. This can be clearly seen in FIG. 1.

With respect to the longitudinal axis 70, the nozzle body 62 extends across at least a third of its total length in the region upstream of the insert, i.e., in the region between the insert 46 and the housing bottom 14.

The channel-shaped expansions 55 are aligned parallelly to the longitudinal axis 70 of the nozzle body 62.

The housing 12 of the rotor nozzle 10 is screwed to a connecting part 88, via which the housing 12 can be supplied with pressurized liquid from a high-pressure cleaning apparatus. For this purpose, the connecting part 88 has an external thread 90, which can be screwed into the second internal thread 44 of the housing lid 16.

Liquid supplied via the connecting part 88 to the housing 12 arrives through the tangential inlets 18 in the internal space 20 of the housing 12 and can exit the internal space 20 via the through channel 72, the nozzle channel 74, the bearing ring 28, and the outlet 22. During operation of the rotor nozzle 10, the internal space 20 is filled with liquid, which is brought into rotation about the housing longitudinal axis 26 by the liquid flowing in through the tangential inlets 18. A liquid column rotating about the housing longitudinal axis 26 thus forms in the internal space 20. The rotating liquid column carries along the nozzle body 62 supported with its spherical front end 64 on the bearing ring 28 so that said nozzle body also rotates about the housing longitudinal axis 26. The nozzle body 62 rests against the circular cylindrical support surface 40 via the O-ring 86 held on the nozzle body 62 in a rotationally fixed manner. The longitudinal axis 70 of the nozzle body 62 is thus tilted toward the housing longitudinal axis 26.

In the region of the insert 46, the liquid flowing around the housing longitudinal axis 26 experiences a deceleration as a result of the baffle surfaces 52, which is struck by a portion of the revolving liquid. In the process, liquid is supplied via the guiding surfaces 54 to respectively one baffle surface 52 so that an effective deceleration of the liquid can be achieved. Upstream of the insert 46, the liquid does however not experience any deceleration. This ensures that the nozzle body 62 is reliably brought into rotation about the housing longitudinal axis 26 by the liquid. In this region, the nozzle body 62 is only located on one side of the housing longitudinal axis 26, whereas the nozzle body 62 crosses the housing longitudinal axis 26 in the region of the insert 46 and the nozzle 66. This can be clearly seen in FIG. 1. The liquid flowing around the nozzle body 62 could drive the nozzle body 62 in the region in which it crosses the housing longitudinal axis 26 to a self-rotation about the longitudinal axis 70 of the nozzle body 62. Since the liquid is, however, decelerated in this region by the flow resistance elements 50, the self-rotation of the nozzle body 62 can be kept low. In addition, the provision of the flow resistance elements 50 achieves a limitation of the rotational speed that the nozzle body 62 has in its rotational movement about the housing longitudinal axis 26. The reduction of the self-rotation of the nozzle body 62 and the reduction of the rotational speed of the nozzle body 62 about the housing longitudinal axis 26 ensure that the liquid jet exiting the housing 12 is only fanned out unnoticeably. The rotor nozzle 10 is therefore characterized by a particularly large cleaning effect.

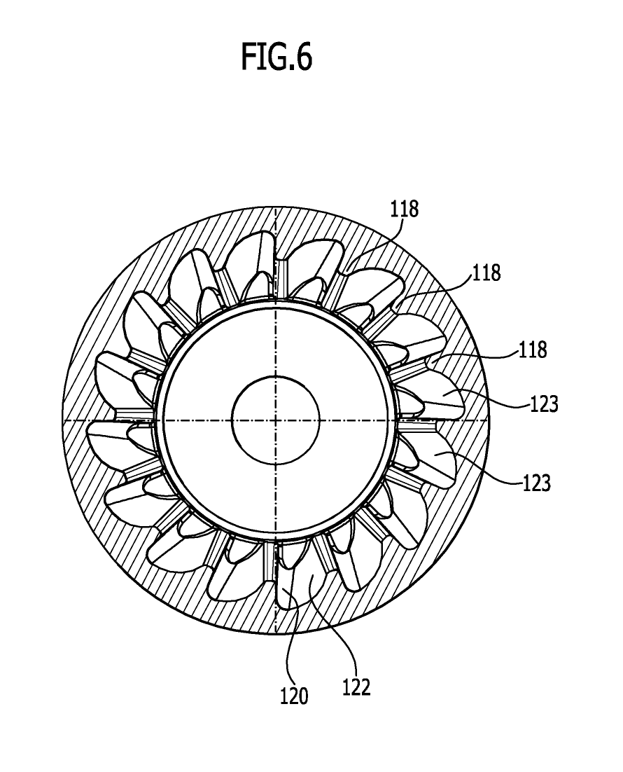

The invention is not limited to the use of a pre-assembled insert 46, which is used in addition to the housing lid 16 and the housing bottom 14. FIGS. 5 and 6 schematically show a housing lid 116 of a second advantageous embodiment of a rotor nozzle according to the invention. The housing lid 116 is designed to be largely identical to the housing lid 16 described above. It is distinguished from the housing lid 16 by the flow resistance elements 118 being formed directly in the housing lid 16. The flow resistance elements 118 are designed to be identical to the flow resistance elements 50 explained above. They respectively have one baffle surface 120, upstream of which is arranged a guiding surface 122. The baffle surfaces and guiding surfaces 120, 122 transition continuously into one another and respectively form a channel-shaped expansion 123. One baffle surface 120 and one guiding surface 122 respectively form an S-shaped contour in a plane aligned orthogonally to the housing longitudinal axis 124. Alternatively, the baffle surfaces and guiding surfaces 120, 122 could also form a sawtooth-shaped contour. In the same way as the guiding surfaces 54 explained above, the guiding surfaces 122 supply liquid to the respective baffle surface 120 following in the revolving movement of the liquid, wherein the liquid is noticeably decelerated on the baffle surface 120.

The housing lid 116 is used as an alternative to the housing lid 16. The housing bottom 14 can also be inserted into the housing lid 116, and the housing lid 116 can be screwed to the connecting part 88. For this purpose, the housing lid 116 also has, on its end region facing away from the outlet 126, an internal thread 128.

In the same way as into the housing lid 16 explained above, the nozzle body 62 can also be inserted into the housing lid 116, which nozzle body is driven by the liquid flowing around the housing longitudinal axis 124 to a rotation about the housing longitudinal axis 124, wherein the rotational speed of the nozzle body 62 can be effectively limited by the provision of the flow resistance elements 118. In addition, the use of the flow resistance elements 118 can limit the self-rotation of the nozzle body 62, without its start-up behavior being impaired however.

1. A rotor nozzle for a high-pressure cleaning apparatus with a housing having at least one inlet opening tangentially and an outlet which is arranged on an end wall of the housing and on which is arranged a bearing with a pan-shaped, centrally broken recess, and with a nozzle body which is arranged in the housing, has a through channel, and is supported with a spherical end in the pan-shaped recess, the longitudinal axis of which nozzle body is tilted toward the longitudinal axis of the housing and which nozzle body is brought into a revolving movement by the liquid flowing through the housing, in which revolving movement the longitudinal axis of the nozzle body revolves on a conical shell and the nozzle body is supported with a contact surface on its circumference on a support surface, wherein several flow resistance elements are arranged downstream of the support surface on the wall of the housing in the circumferential direction at a distance to one another, which flow resistance elements respectively have one baffle surface protruding into the housing for impinging liquid, wherein a guiding surface is arranged directly upstream of each baffle surface with respect to the flow direction of the liquid, which guiding surface is continuously adjoined by the baffle surface, wherein the guiding surface is aligned obliquely to a radial plane with respect to the longitudinal axis of the housing.

2. The rotor nozzle according to claim 1, wherein the baffle surfaces are at least in sections arranged in a radial plane with respect to the longitudinal axis of the housing.

3. The rotor nozzle according to claim 1, wherein the guiding surfaces are curved in the shape of an arc at least in sections.

4. The rotor nozzle according to claim 1, wherein each guiding surface, in combination with the baffle surface adjoining the guiding surface, forms a channel-shaped expansion of the internal space of the housing.

5. The rotor nozzle according to claim 1, wherein a plurality of baffle surfaces and guiding surfaces are arranged alternatingly one behind the other with respect to the flow direction of the liquid.

6. The rotor nozzle according to claim 1, wherein each guiding surface, in combination with the baffle surface adjoining the guiding surface, forms an S-shaped or sawtooth-shaped contour in a plane aligned orthogonally to the longitudinal axis.

7. The rotor nozzle according to claim 1, wherein the flow resistance elements are formed in a wall of the housing.

8. The rotor nozzle according to claim 1, wherein the flow resistance elements are formed by an insert that is adapted to be inserted into the housing.

9. The rotor nozzle according to claim 8, wherein the insert has a constant wall thickness along its circumference.

10. The rotor nozzle according to claim 8, wherein the insert is adapted to be connected to the housing in a rotationally fixed and axially unmovable manner.

11. The rotor nozzle according to claim 8, wherein the insert is adapted to be screwed to the housing and has a stop surface, which, in the final position of the insert, rests against an inner shoulder of the housing.

12. The rotor nozzle according to claim 11, wherein the insert has an external thread, which interacts with a first internal thread of the housing.

13. The rotor nozzle according to claim 11, wherein the screw-in direction of the insert corresponds to the flow direction of the liquid in the internal space of the housing.

14. The rotor nozzle according to claim 12, wherein the first internal thread is a multi-start thread.

15. The rotor nozzle according to claim 12, wherein the rotor nozzle has a connecting part that is adapted to be connected to the housing to connect to a liquid supply line.

16. The rotor nozzle according to claim 15, wherein the connecting part has an external thread, which is adapted to be screwed into a second internal thread of the housing.

17. The rotor nozzle according to claim 16, wherein the direction of rotation of the second internal thread corresponds to the direction of rotation of the first internal thread.

18. The rotor nozzle according to claim 16, wherein the direction of rotation of the second internal thread is opposed to the direction of rotation of the first internal thread.

19. The rotor nozzle according to claim 15, wherein the connecting part is connected in a rotationally fixed manner to the housing.
